(19) United States
(12) Patent Application Publication
(10) Pub. No.: US 2016/0207194 A1
(43) Pub. Date: Jul. 21, 2016

(54) STABILIZATION SYSTEM FOR ROBOTIC TECHNOLOGY

(71) Applicants: Anne J. BLOOD, Arlington, MA (US); Hans C. BREITER, Lincoln, MA (US); John K. KUSTER, Boston, MA (US)

(72) Inventors: Anne J. BLOOD, Arlington, MA (US); Hans C. BREITER, Lincoln, MA (US); John K. KUSTER, Boston, MA (US)

(21) Appl. No.: 14/916,061

(22) PCT Filed: Aug. 28, 2014
(86) PCT No.: PCT/US14/53130

§ 371 Date: Mar. 2, 2016

Related U.S. Application Data
(60) Provisional application No. 61/872,913, filed on Sep. 3, 2013.

(51) Int. Cl. B25J 9/10; B25J 19/00; B25J 9/16

(52) U.S. Cl. CPC B25J 9/1075; B25J 9/1615; B25J 19/0008; G05B 2219/39454; G05B 2219/40236

(57) ABSTRACT

A motor control system to be applied to robotic technology, the motor control system comprising at least two actuators that each include a first receiver and a second receiver. The system is comprised of a movement control system that communicates a first signal to the first receivers, the first signal indicative of a movement profile; and a stabilization control system that communicates a second signal to the second receivers, the second signal indicative of a stabilizing profile. The stabilizing profile produces mechanical forces that are to some degree antagonistic to the mechanical forces of the movement profile, and the actuators are mechanically arranged in a way that such antagonism can take place. The function of the stabilization system may include controlling overall stability, local stability, and/or local accuracy/precision/speed of movement, and may be implemented on a feedforward and/or feedback basis.

### RELATED APPLICATIONS

This application claims priority to U.S. Provisional Application No. 61/872,913 filed on Sep. 3, 2013, the entire disclosure of which is hereby incorporated herein by reference.

### STATEMENT REGARDING FEDERALLY SPONSORED RESEARCH

This invention was made with government support under NS052368 awarded by the National Institutes of Health. The government has certain rights in the invention.

### BACKGROUND

The present disclosure relates to the control and operation of robotic technology. More particularly, the disclosure relates to a control scheme and system for improving stabilization and precision of robotic movement, while simultaneously reducing the computational complexity and load of doing so. The disclosure may also relate to improving (in a paradigm shifting manner) signal detection relevant to human motor control, such as voice recognition or functional interpretation of peripheral neural signals, as technology currently attempts to achieve in the field of robotic limbs (prosthetics).

Advancing the knowledge of human motor control has the potential to advance the field of robotics. This would be particularly true if information about human motor control were to provide principles that increase the capacity, efficiency, flexibility, or accuracy/precision of robotic technology. The tasks achievable by robotic technology are currently limited by the current approach to programming motor control, and, thus, the range of functions that such technology can serve is also limited. One specific way in which these limitations affect the technology is that this technology has not yet been able to achieve the, stability, sophistication, and qualitative features of human movements. This problem is important, not only for the performance of humanoid robots, but for any machine that attempts to maximize both stability and precision of movement, and mimic the astounding range and flexibility of movement characteristic of humans. In particular, robot stability and control of precision movements are severely limited by the current approaches to programming these functions, which require too vast a degree of computational complexity to achieve anywhere near the level of stability and precision achieved by a human.

Current robotics systems typically divide control processes into sub-tasks. In this regard, the sub-tasks are performed by complementary sub-systems that coordinate to effectuate control. Specifically, so called “hybrid” control systems utilize two separate computations, such as position and force, to control motor output. A number of hybrid control schemes exist for robotics; however, no robotic system has segregated tasks into separate movement and stabilization algorithms.

Passive dynamics is another existing concept that significantly reduces the computational power required for robot actuation and makes movement more human-like. A passive dynamic control system utilizes momentum to propel the robot through parts of a movement, rather than mechanically programming each individual movement increment. Although robots currently using passive dynamics are far more computationally efficient than their more fully programmed counterparts and produce something that looks far more like real movement, these robots are less mechanically stable than their more-fully-programmed counterparts. Although complex learning algorithms have been proposed to train unstable robots to be significantly more stable (leading to “quasi-passive” dynamic robots), stability is gained only indirectly by improving movement programs themselves, rather than truly offering greater mechanical stability. Furthermore, such learning reintroduces the significant computational demand/complexity saved by the passive movements, because each error and/or obstacle must be anticipated and/or corrected for exactly, and thus advances in stability have not been significant.

Parallel manipulators are currently used in robotics and include parallel construction of the materials used to implement discrete, precision tasks. Structurally speaking, parallel manipulators are constructed like a set of antagonistic muscles around a limb, which allows more “slack” in the system for errors in any given actuator in the system. In particular, increased precision is achieved by the fact that each movement is a “group” effort and does not depend on the precision of any one actuator. In addition, parallel manipulators offer structural stability due to having three or more “legs”, as compared with bipedal robotic systems. However, the stability of parallel manipulators is limited to the mechanical properties of their construction, and does not include any component of functional opposition that would lead to a far greater range and magnitude of stabilizing function. In addition, parallel manipulators are currently used as individual units and not as components of a larger system.

Unfortunately, because the current mechanisms for implementing stability and movement correction rely on precise correction of errors and adaptation to changes in trajectory, this requires a very high level of programming, computational power and speed; in addition, this mechanism means that even small errors in correction calculation may still lead to mechanically unstable systems. Furthermore, current robotic technology exhibiting a high level of precision of movement does so at the expense of reduced flexibility and range of potential movements even in the absence of error, because each movement must be pre-programmed down to an exact set of speeds, vectors, force, and so forth. Finally, although parallel manipulators provide more stability and precision than other robotic technology, they lack stability function beyond their mechanical structure, and are manufactured as stand-alone units which have not been integrated as components of a larger, dynamic system.

Therefore, a need exists for a control system in robotic technology that (1) substantially advances accuracy and precision of movement and overall stability of the moving system, relative to existing technology, (2) allows for the flexibility and complexity characteristic of life-like motion, and (3) is usable in a wide range of applications.

### BRIEF SUMMARY OF THE INVENTION

The present invention reduces the aforementioned drawbacks by providing systems and methods for robotic control that utilize a system that provides mechanical stability that does not require exact calculation of movement error or deviation from center of mass. Specifically, the system increases the stability of the robot to begin with, rather than merely correcting errors that are made or anticipated, such that stability now becomes a tractable, non-infinite problem. The invention dictates first, that separate programs are used to control movement versus stabilization/precision. The invention dictates second, that the stabilization/precision program is implemented using some combination of stabilization actuator “co-contraction” (described below in figures) that provides stability and exerts variable levels of mechanical opposition/antagonism to movement. Such co-contraction will be stereotyped (like a postural reflex) based on the type of movement performed, and will have the ability to vary in amplitude. The resulting stabilization may be exerted across the overall robotic structure (i.e., to prevent falls), or locally, to provide greater control of specific movements (i.e., a robotic hand or arm movement).

In one aspect, the present invention provides a motor control system for maximizing stability and precision function of robotic technology, or an algorithm to be used for human motor signal processing. The motor control system includes actuators that each possess a first receiver and a second receiver. A movement control system communicates a first signal indicative of a movement profile to the first receiver. A stabilization control system communicates a second signal indicative of a stabilizing profile to the second receiver(s), which may or may not be in the same actuator that the movement profile was sent to. The stabilizing profile will most often be sent to multiple actuators, as its function is often implemented by sending equal and opposite signals to mechanically antagonistic actuators. The resulting “co-contraction” of actuators will also antagonize the movement profile to some degree; the degree will be related to the function being served (e.g., preventing falls will be associated with complete opposition to the movement, while increasing precision will be associated with less opposition to the movement), and will be determined by the amplitude of the stabilizing signal sent (i.e., the net force of the stabilizing signals in one direction may be greater or less than the net force of movement in the opposite direction). It is important to note that opposition of movement takes place only at the mechanical level across actuators (the force of one actuator pulling against the force of another); the signals sent to a given actuator will not oppose each other, but may be different in nature.

The foregoing and other aspects and advantages of the invention will appear from the following description. In the description, reference is made to the accompanying drawings which form a part hereof, and in which there is shown by way of illustration some of the general mechanisms and principles of the invention. These are followed by a detailed description of the invention, including both general description and descriptions how such mechanisms may be applied to robotic technology (i.e., preferred embodiments of the invention). Such illustrations and descriptions do not necessarily represent the full scope of the invention, however, and reference is made therefore to the claims and herein for interpreting the scope of the invention.

### DESCRIPTION OF DRAWINGS

The invention will be better understood and features, aspects and advantages other than those set forth above will become apparent when consideration is given to the following detailed description thereof. Such detailed description makes reference to the following drawings. FIG. 1 refers to component (1) of the invention, as described in [0009] and [0026]. FIGS. 2-12 refer to component (2) of the invention, as described in [0009] and [0026].

FIG. 1 is a schematic representation of a stabilization control system combined with a movement control system, according to one embodiment of the invention. The movement control system may be part of an existing robotic system, or a new robotic system. In either case, the movement control system would be constructed using existing technology for robotic movement. The stabilization control system will be constructed according to the principles described in FIGS. 2 through 12. All actuators illustrated schematically in FIGS. 2 through 12 will be constructed as connections running between joints, rather than using actuators at the joints themselves. Detailed descriptions of materials used for such actuators can be found below.

FIG. 2 is a side view of a robotic arm according to one embodiment of the invention. FIGS. 3 through 5, as well as 10 and 11, illustrate the concepts that drive the stabilization mechanism for this embodiment, and how it provides an advantage for fine motor control. Points relating to stabilizing mechanisms are shown in red, while points relating to movement, movement error, or external forces (e.g., gravity) are shown in blue.

FIG. 3 is a side view of the robotic arm of FIG. 2 showing the direction of force of a first actuator, A, when it shortens (or “contracts”).

FIG. 4 is a side view of the robotic arm of FIG. 2 showing the direction of force of a second actuator, B, when it shortens (or “contracts”).

FIG. 5 is a side view of the robotic arm of FIG. 2 showing the antagonistic effect that simultaneous shortening (“contraction”) of actuators A and B (from FIGS. 3 and 4, red dashed lines this figure) exert on each other, and thus, also on movement, movement errors, and external forces (e.g., gravity) (movement/external forces shown in blue dashed lines). The degree of antagonism is determined by the contraction amplitude(s) of actuators A and B; that is, it may range from mild to complete antagonism of a movement or external force. When movement is desired, the net amount of antagonism to the movement is less than the force of the movement itself. Stability may be achieved by (1) co-recruitment of antagonistic actuators (i.e., a global response, non-specific to the direction of deviation), or (2) by recruitment of actuators in a single direction to counteract movement in the opposite direction (i.e., a direction-specific response). In either case, the mechanism involves recruitment of forces antagonistic to the direction(s) of instability or movement; in the case of (1), such antagonism can be accomplished without needing to know the direction of instability or movement, which is often unpredictable in robotic technology. Importantly, for this invention, the stabilizing forces would be functional/dynamic and not simply structural, and could (but would not have to) use the same actuators/architecture used to implement movements.

FIG. 6 is a front view of a robotic trunk according to one embodiment of the invention. FIGS. 7 through 9, as well as 12, illustrate the concept that drives the stabilization mechanism for this embodiment, and how it provides and advantage for global stabilization of a robot. Points relating to stabilizing mechanisms are shown in red, while points relating to movement, movement error, or external forces (e.g., gravity) are shown in blue.

FIG. 7 is a front view of the trunk of FIG. 6 showing the direction of force of a first actuator, A, when it shortens (or “contracts”).

FIG. 8 is a front view of the trunk of FIG. 6 showing the direction of force of a second actuator, B, when it shortens (or “contracts”).

FIG. 9 is a front view of the trunk of FIG. 6, showing the antagonistic effect that simultaneous contraction (i.e., shortening) of actuators A and B (from FIGS. 7 and 8, red dashed lines this figure) exert on each other, and thus, also on movement, movement errors, and external forces (e.g., gravity). The degree of antagonism is determined by the amplitude of function in actuators A and B; that is, it may range from mild to complete antagonism of a movement or external force. When movement is desired, the net amount of antagonism to the movement is less than the force of the movement itself. Stability may be applied by (1) co-recruitment of antagonistic actuators, or (2) by recruitment of actuators in a single direction to counteract movement in the opposite direction. In either case, the mechanism involves recruitment of forces antagonistic to the direction(s) of instability or movement; in the case of (1), such antagonism can be accomplished without having to know the direction of instability or movement, which is often unpredictable in robotic technology. Importantly, for this invention, the stabilizing forces would be functional/dynamic and not simply structural, and could (but would not have to) use the same actuators/architecture used to implement movements.

FIG. 10 is a side view of a robotic arm showing how the actuators in FIGS. 2-5 exert an effect similar to symmetrical and antagonistic stakes or pulleys (such as would hold up a tent) attached to an object to stabilize it, whose forces counteract each other exactly. In this particular case, we show the effect of stabilization around a joint (or joints) for a robotic component that is not supported by the ground (e.g., a limb extending outwards in space). Stabilization forces could exist in all planes in which there are antagonistic actuators (the more pairs of antagonistic actuators, the more potential stability). Red dashed lines represent a theoretical illustration of antagonistic forces that produce mechanical stability around each joint for this element of the system.

FIG. 11 is a side view of a robotic arm showing the effect of stabilization toward a certain arm position for a robotic component that is not supported by the ground (e.g., a limb flexing towards the body, such as when moving through a tight space) using co-contraction (i.e., shortening) of groups of synergistic actuators. Stabilization forces would be exerted in a single direction (the more actuators with this directionality, the more potential stability). Red dashed lines represent a theoretical illustration of synergistic (rather than antagonistic) forces that produce mechanical stability of a certain position for this element of the system.

FIG. 12 is a front view of a bipedal robot showing how the actuators in FIGS. 6-9 exert an effect similar to symmetrical and antagonistic stakes or pulleys (such as would hold up a tent) attached to an object to support it, whose forces counteract each other exactly. In this particular case, we show the effect of stabilization with reference to the ground, including an anti-gravity effect on the entire system. Stabilization forces would exist in both left/right (shown here) and front/back planes. Red dashed lines represent a theoretical illustration of antagonistic forces that produce mechanical stability for the system.

While the invention is susceptible to various modifications and alternative forms, the general mechanisms, concepts, and principles of the invention are illustrated in the drawings, and are herein described in detail in the following text. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

There are two key components to this invention: (1) The first component is that the invention operates by separating movement processing from stabilization processing and relaying a separate movement signal and a separate stabilization signal to the actuation system. (2) The second component is that the movement and stabilization signals are mechanically antagonistic to one another using functional and structural mechanisms described in the figures, and in the text below. Thus, while this invention dictates (1) the separation of movement and stabilization processing and (2) the specifics of the mechanical and functional mechanisms by which stabilization is implemented, the invention does NOT specify the means by which movement is coded and processed; movement may be implemented by any existing robotic movement system, including hybrid systems and passive dynamics systems. Paragraphs [0027]-[0040] describe the general concepts of the invention, paragraphs [0041]-[0056] describe specific areas of robotics and/or signal processing in which our invention might be applied to advance the technology, and paragraphs [0057]-[0064] summarize information regarding the conception and novelty of the invention.

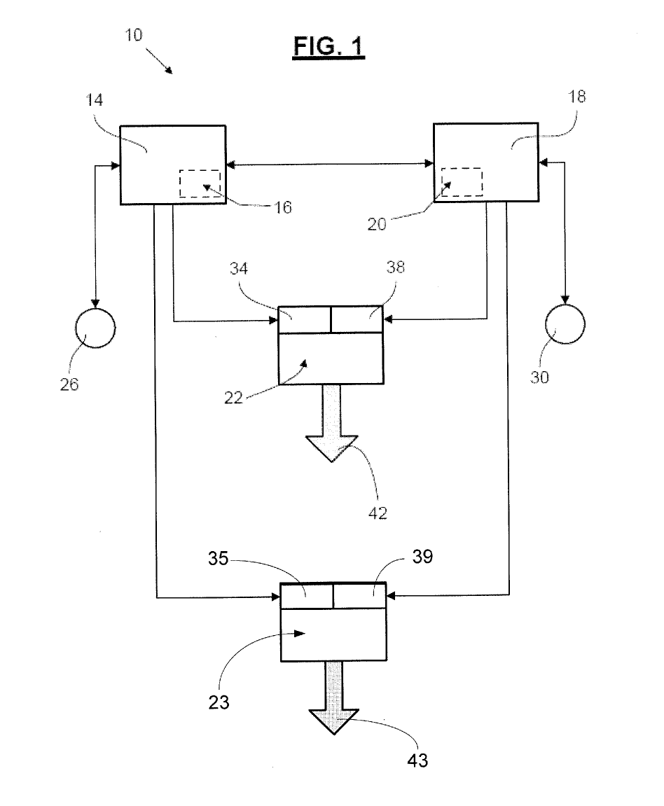

FIG. 1 shows a robotic actuator system 10 that includes a movement control system 14, a stabilization control system 18, and two actuators 22 and 23. The movement control system 14 includes a movement profile 16 that determines the movement profile 16 delivered to actuator 22. The movement profile 16 may be stored in a memory that is part of or accessed by the movement control system 14. The movement control system may be part of an existing robotic system, or made new using existing technology for robotic movement. In one embodiment, the movement control system 14 may be programmed with passive dynamics as discussed above.

The stabilization control system 18 includes a stabilizing profile 20 that increases the stability of the movement enacted by actuator 22 by sending signals either (a) to actuators 22 and 23, or (b) to actuator 23 alone. In example (a), overall stability is implemented by co-contraction (i.e., shortening) of antagonistic actuators, and the movement and stability signals sent to actuator 22 are summed, while actuator 23 receives only a stability signal. In example (b), stability is achieved simply by creating an antagonistic force to actuator 22, using actuator 23. The stabilizing profile 20 may be stored in a memory that is part of or accessed by stabilization control system 18. The stabilization control system 18 is separate from the movement control system 14. To this point, the stabilization control system 18 and movement control system 14 may be implemented in separate hardware, but need not be so configured. As will be described, the stabilization control system 18 and movement control system 14 are typically in mechanical opposition, such that the movement profile 16 and the stabilizing profile 20 are designed accordingly. In other words, although the movement control system 14 and the stabilization control system 18 may be complementary or cumulative within a given actuator, they will be oppositional across actuators and the resultant movement more stable.

The stabilization system actuators are best constructed as muscle-like components between joints (as shown in the Figures), although other possible mechanisms might be designed. Muscle-like components can be added to existing products with joint actuators, or manufactured as a new product with muscle-like components that execute both movement and stabilization commands. Two signal types are sent separately to the “muscle-like” material, and the amount that this material shortens (mimicking the effects of muscle contraction) reflects the net magnitude and quality of signal sent. Muscle-like components can be constructed using any material that mimics a human muscle, stretching between joints, with the purpose of controlling position and movement at the joint by changes in the length of the material stretching between joints. Implementing this mechanism using materials stretching between joints, rather than at joints (as frequently used on robot actuators), not only allows the ability to create a control system with antagonistic muscles, but also achieves greater leverage of movement/stability than movement/stability by joint actuators, due to general mechanical principles. In addition, an advantage of constructing actuators between joints is that the level of length or “stretch” of actuators (like muscle stretch receptors in humans) can be used to calculate position and set limits that further control stability; other inventions using impedance at joints themselves do not have this option for setting limits and feedback to the system, and would require feedforward and feedback control systems to be operated separately. Existing materials that may be used to construct actuators for the stabilization system include pulleys, hydraulics, and electroactive jelly-like substances. These materials have been used in robotics previously, but not to implement the mechanism (e.g., recruitment of components antagonistic to movement) proposed in the present application. In order to achieve the equivalent of a muscle contraction, synthetic muscles need to shorten the amount that a muscle contraction would shorten the muscle.

A first sensor 26 is associated with the movement control system 14 and a second sensor 30 is associated with the stabilization control system 18. The sensors 26, 30 provide information to the respective systems 14, 18 about the net motion enacted by the actuators or other system factors (such as actuator length/“stretch”), as desired. The systems 14, 18 may communicate with more than one sensor each, or no sensors.

The actuator 22 includes a movement receiver 34 arranged to receive signals from the movement control system 14 and a stability receiver 38 arranged to receive signals from the stabilization control system 18. Similarly, the actuator 23 includes a movement receiver 35 arranged to receive signals from the movement control system 14 and a stability receiver 39 arranged to receive signals from the stabilization control system 18. In this way, the actuators 22 and 23 can be controlled by both the movement profile 16 and the stabilizing profile 20 separately without prior summation. However, the signals to each individual actuator may also be summed prior to transmission to the actuator, given that opposition occurs across actuators and not within an actuator (i.e., it is not essential that signals remain separate to achieve opposition). The actuators 22 and 23 are operated according to the received signals to produce the desired output, 42 and 43, respectively, which together determine the net motion depending on (1) the mechanical relationship of actuators 22 and 23 and (2) the amplitude of 42 relative to 43. In all embodiments, actuators are arranged in such a way that at least two actuators are positioned to produce forces that oppose/antagonize each other; in this way the mechanical construction of the invention resembles the mechanical construction of a parallel manipulator. A movement profile may be implemented by a single (or multiple) actuators, while the stability profile is implemented using either a set of actuators that are antagonistic and/or synergistic to each other, which may include the same actuator(s) used to implement the movement profile, or a single actuator that is structurally and functionally antagonistic to the movement actuator. Such mechanisms can then be applied to implement global stability function, such as for balance and sustained postures, and to local control of movements themselves (e.g., arm movements) or other fine motor function, such as speech.

For applications to signal processing, this invention states that any given motor signal is likely to reflect the summation of at least two separate signal types, and thus, raw signal is uninterpretable until decomposed into its components. Since movement and stability signals in a human emanating from the brain are expected to occur at different frequencies, one proposed way to decompose the signals would be to use fourier analysis. Another approach would be to simply assume that signals sent to muscles antagonistic to a movement may also be sent to the agonist muscle itself and thus, the stability signal component in an agonist muscle could be inferred from the signal in the antagonistic muscle, and subsequently removed from the agonist signal to uncover the “movement” signal itself. Approaches to “neural integration” for prosthetics currently use only coarse signal information and do not attempt to deconstruct signals into components; thus, the approach of this invention would lead to a paradigm shift in our ability to accurately interpret such signals.

In local control of movement, the present motor control system shown in FIG. 1 can be used to guide a moving robotic component itself, or to stabilize a core region proximal to the moving component. In these cases, signals from both a movement control system and a stabilization control system might be delivered to a single muscle or motor unit (i.e., actuator 22), and the resulting activity reflects the summation of the two. However, the two signals are best delivered separately to the actuator 22, rather than being summated at a higher level, particularly because the signal timing and properties of the two channels may be different. Moreover, separating these two systems also enables use of different actuators for the two systems in the case that stabilization control systems are added to existing technology with joint actuators. The above mechanism provides a fairly straight-forward way of implementing either feedforward or feedback control, analogous to a set of training wheels providing stability alongside the main wheels of a bicycle with the main wheels being the movement program and the training wheels being the stabilization program. Using this mechanism, control can be programmed without requiring immense computational power, and without knowledge of the exact errors that might take place. Given that many of today's robots have muscle-like components, this mechanism is readily adaptable to a variety of existing technologies and materials.

The stabilization control system 18 acts in opposition to movement control system 14 to varying degrees depending on the particular robotic implementation and level of desired control. For example, movement accuracy/precision or stopping a movement are two functions that can be achieved by varying the level of resistance exerted by the stabilization control system 18 and resultant signal. This oppositional mechanism comes at a cost of mildly increased energy to run the system 10. This increase in energy does not have an impact on the feasibility of the robotics design, but dramatically reduces programming complexity. Given that coding complexity is one factor currently limiting optimal control of robotic technology, this mechanism significantly reduces this limitation. Another significant limiting factor in advancing movement accuracy in robotics is the cost of recoding existing robotic technology with an interface between movement and corrective feedback mechanisms. In the case that improvements on existing machines are preferred, the present invention can be implemented to avoid this limiting factor by running the movement control system 14 and stabilization control systems 18 in parallel, without needing to re-program existing movement programs.

The two channel approach (e.g., movement control system 14 and stabilization control system 18) utilizes (1) a master, stored movement program, and (2) an accompanying, simultaneous posture/stabilization program that offers varying degrees of opposition to the movement program. One principle of this, is that a balance of efficiency, flexibility, stability, and accuracy/precision of movement in robotic technology can be achieved using this pair of mechanisms.

Unlike current “hybrid” control systems used in robotics, the present invention uses commands from two separate channels, that act on different receivers (e.g., receivers 34/35, 38/39) in the same actuators (e.g, actuators 22, 23). The separation of these channels means that if one fails, the other can continue working and help to compensate for the loss or malfunction of the other system (i.e., it increases system redundancy). The two channels, when working properly, also increase stability by mechanically opposing each other. These design advantages of separating the channels distinguish this approach from, and show advances from, existing hybrid control systems in robots in which channels are separated simply because of a computational problem in trying to combine them. Finally, it should be noted that there is strong communication between the two channels, particularly relating to feedback-driven stability, as well as to temporally correlating feedforward programs.

The movement control system 14 may be implemented using a variety of existing, feedforward movement programs already coded in a robot. The stabilization control system 18 will be implemented using a mechanism that is qualitatively different from simply correcting movement errors based on movement feedback, or predicted error. This configuration is advantageous for robotics because it allows many fewer master motor programs to be stored, leading to increased coding efficiency and a broader range of possible movements. Specifically, virtually unlimited variations of a single movement program could be achieved by different alterations to the associated stabilization control parameters (such as, speed, force, and accuracy/precision).

Two or more parallel channels also provide a greater range and level of control of movements. Although posture-like correction in the form of feedback or pre-correction has been used in robotics, it has been implemented as the correction of a movement simply by adjusting the vector of the movement signal itself.

A passive dynamic movement program would be the preferred movement control system used along with the stabilization control system of this invention when trying to closely emulate human movement. Robots currently using passive dynamics are far more computationally efficient than their more fully programmed counterparts and produce something that looks far more like real movement; however, these robots are currently less mechanically stable than their more fully programmed counterparts. Although complex learning algorithms have been proposed to train unstable robots to be significantly more stable (leading to “quasi-passive” dynamic robots), stability is only gained indirectly by improving movement programs themselves, rather than truly offering greater mechanical stability. The current invention would complement passive dynamics by providing greater mechanical stability to the robot, and requiring less learning to achieve this stability.

Components of this invention may be practiced using the mechanical principles of parallel manipulators. Specifically, some features of parallel manipulators suggest the principles by which they are constructed and operate would be an appropriate approach to implementing the mechanism proposed above for posture/stabilization, with “rules” specific to the current invention (as described in the figures and figure legends). Features of parallel manipulators include parallel construction of materials used to implement stabilization (like a set of antagonistic muscles around a limb) that allows more “slack” in the system, that is, errors in one manipulator tend to be absorbed and averaged out with other manipulators, rather than perpetuating through the system. Although parallel manipulators are not currently designed to shorten and lengthen like the muscle-like components required to implement the stabilizing profile of this invention, if such function could be combined with parallel manipulator mechanical properties, this combination of features would form a mechanism for stability that is similar to the muscle co-contraction hypothesized by the Applicants to underlie stability of human motor function. Thus, this invention proposes that a parallel manipulator-like concept can be applied to construct robotic “muscles” around each body segment to act as stabilization “units”, while passive dynamics or other existing approaches to robotic movement can be used to code movement itself. There is existing technology for “muscle” units in robots, which may consist of elastic nanotubes or electroactive polymers. Other robots use elastic pulley construction to simulate the function of muscles.

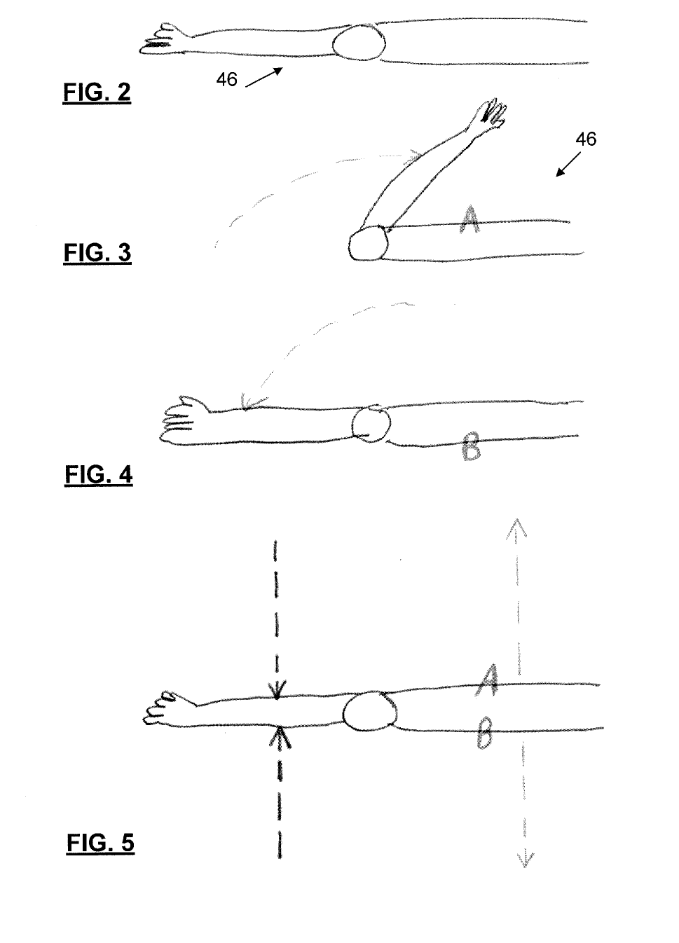

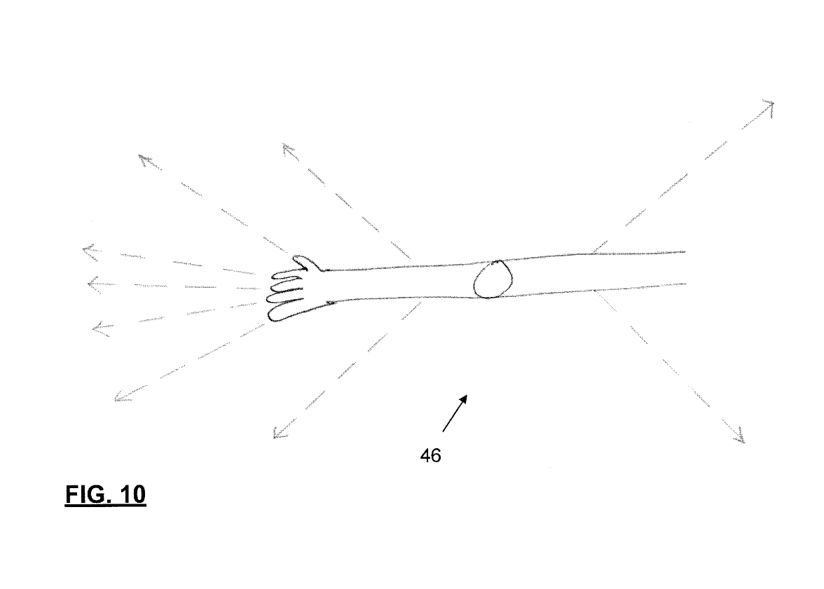

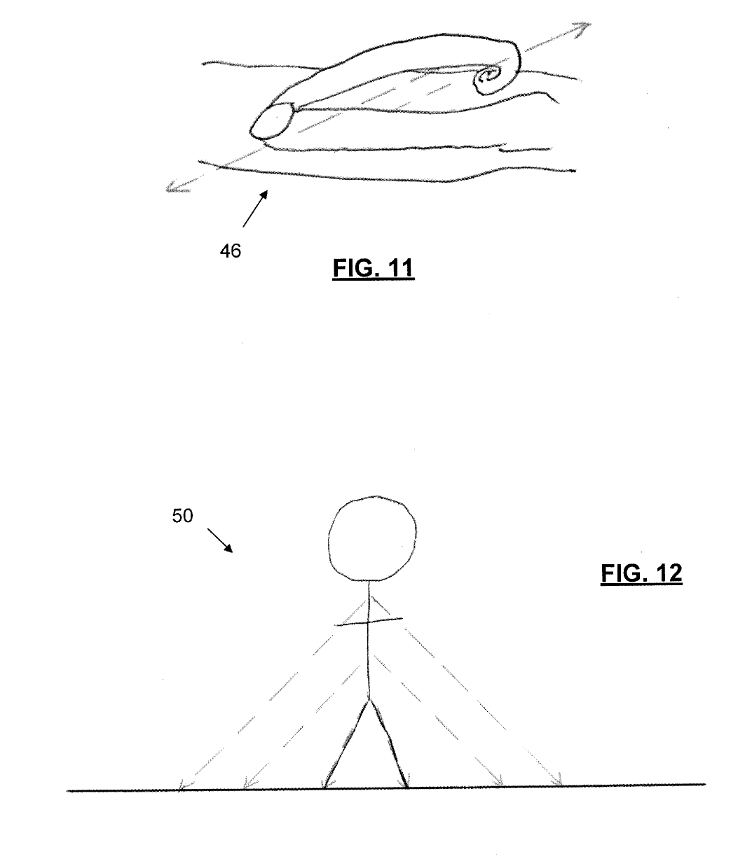

Four examples of how the overarching principals of the invention may be applied will hereinafter be described with reference to the general mechanisms of the invention illustrated in FIGS. 2-12.

A first example of implementing the inventive concept involves improving human prosthetics as described below using the mechanisms illustrated in FIGS. 2-5. In general, current upper limb prosthetics are very difficult to use, and this invention is expected to improve two aspects of prosthetics that are currently limiting to the technology. These improvements address (1) the way that prosthetics are manufactured and controlled, and (2) the way that neural information from the limb stump is interpreted in the case that prosthetics are driven by human neural signals. Regarding (1), the ability to increase stability provided by the mechanism proposed in this invention allows for increased precision of fine motor control (in the moving component itself) and increased ease of learning new motor tasks (because of error reduction/correction) with upper limb prosthetics. Regarding (2), the invention improves the way in which neural signals are interpreted, based on recent advances in our understanding of human motor control. These mechanisms can be used to improve the accuracy of lower limb, in addition to upper limb, prosthetics. Currently, there is more success with lower limb prosthetics because they do not require as much fine motor control; however, there is still clearly room for improvement in this technology as well.

One limitation of prosthetics that has made them difficult to use is the lack of ability to modulate (in the way that a human would) the “stiffness” background against which a movement is performed to increase control of the movement and reduce the impact of errors. Thus, this invention offers a solution to this problem in the following way, based on advances in our understanding of human motor control: With increased co-contraction of prosthetic muscle-like actuators in the background (i.e., uniformly increasing the tension across all muscle-like actuators in and adjacent to the moving body part), a given error or deviation from the planned movement will have a lesser impact (i.e., less deviation from the planned trajectory) and return more quickly to the correct trajectory. This mechanism uses commands that run in parallel to the commands for a particular movement itself, and can be implemented by distinct programming and/or materials, making it possible to add the stabilization mechanism to existing technology. The between-joint actuators proposed as a primary mechanism in this invention also provide greater leverage and degrees of freedom for achieving such “stiffness” than would be offered by impedance at the joint itself.

Accordingly, “muscle-like” actuator components (see Figures and [0028]) can be added to existing products with joint actuators, or manufactured as a new product with muscle-like actuator components that execute both movement and stabilizing profiles. A simple embodiment of such a product implements graded settings for arm stability (increasing or decreasing the level of tension created by co-contraction) while making a given movement, which could be selected by the user. For example, if the user was learning a new movement or wanted to perform a task very precisely, he/she could increase the stability setting, while if the user wanted to perform a well-learned task rapidly and fluidly, he/she could decrease the stability setting.

A second reason that prosthetics are currently difficult to use may relate to the fact that the most advanced current upper limb prosthetics make use of neural signals coming from the upper arm stump. However, this presents a challenge because the most commonly accepted neural models for motor control do not know how to interpret these neural signals, and thus the information extracted does not qualitatively match the motor information the brain sent. This conundrum is clearly reflected in the difficulty individuals have using these prosthetics; there are only rare instances when they are used easily and successfully. The motor control model on which the current invention is based indicates that the signal from a given nerve bundle reflects the superimposition of a movement and a stabilization signal. Thus, this invention supplies the specification that the nerve signal needs to be decomposed into its subcomponents to be transmitted as the correct information to the prosthetic device. By decomposing the signal from the nerve bundle and using the decomposed signal to control an actuator system such as illustrated in FIG. 1, substantial advantages can be realized.

With respect to performing the decomposition referred to in [0044], “movement” versus “stability” commands are expected to generate different frequency signals, making it possible to do such a decomposition using a fourier analysis. Current approaches to neurally guided prosthetics assume that there is a single signal coming to a given muscle, not that the signal to a given muscle may be the composite of two qualitatively distinct signals. Thus, the information used by these approaches may be completely incorrect; this may help to explain why current neurally-guided prostheses are so difficult to use. In addition to taking into account that there are two qualitatively and quantitatively different components to the motor signal, the invention also specifies that relevant signals may be transmitted to all muscles in the arm, rather than just the agonist muscle(s) for a particular movement. The approach of this invention would thus make more complete and accurate use of the neural information emanating from the limb stump, thus allowing the user to guide movement as they did before losing a limb, rather than having to learn from scratch by trial and error.

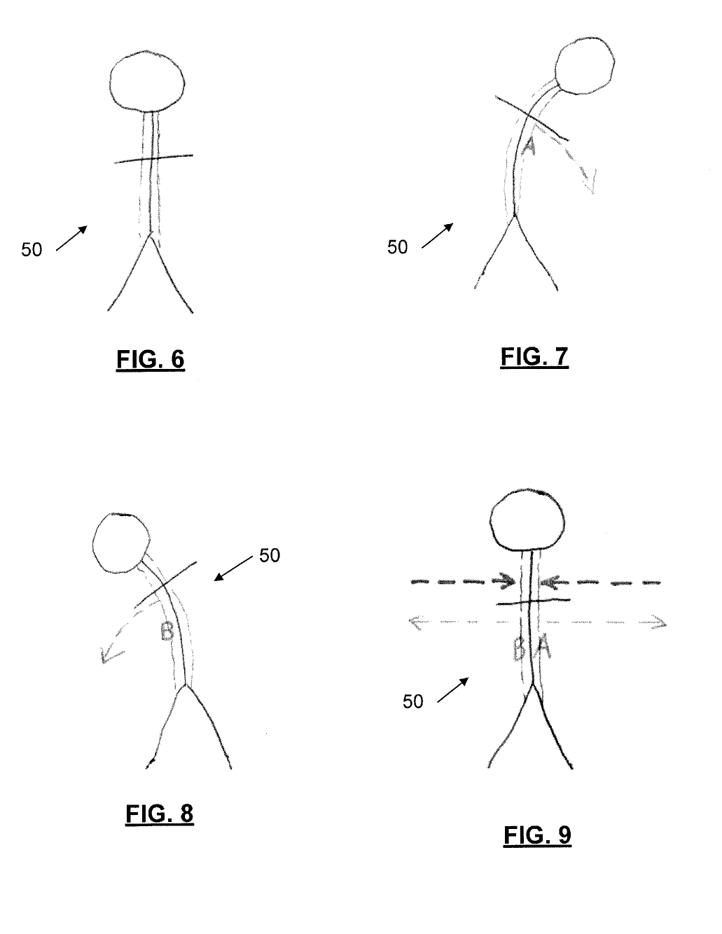

A second example of implementing the inventive concept involves reducing a computational load and complexity required to correct errors and maintain stability in freestanding/moving robots as described below with respect to FIGS. 6-9. This problem currently limits the degree of stability that can be achieved in robotic technology.

Specifically, the mechanism for stability in this invention differs from technology used in current robotic systems that aim to correct for anticipated or perceived errors. Errors in the trajectory of robot movement arise from a range of potential sources, including manufacturing and assembly variations, unexpected obstacles, and the like, and are critical issues that must be dealt with for robotic systems to perform well. However, the complexity of the approach currently used in robotics means that only very limited error correction can be achieved, thus significantly limiting the capacity of robotics. The current invention supplies a transformational approach to dealing with error prevention/correction that is qualitatively different than existing approaches and which is expected to lead to substantial improvements in the ability to modulate stability and precision in robotic technology. Moreover, this invention minimizes the cost of implementation because the invention can be used as an add-on to much of existing technology, rather than requiring a complete turnover of equipment. There are at least two ways in which this invention is different from existing robotic technology for error correction and stabilization.

A first difference is that the feedforward stability component of the invention reduces error from the start, rather than requiring a calculation to correct errors. This is most applicable to fine motor skills, including learning new skills. It is also applicable to robots that detect and grasp moving objects, which requires honing in on these objects and making rapid adjustments along the way. The mechanism by which it functions is that each deviating force moving the robot away from the expected trajectory has less impact (i.e., less error) with the added resistance of the stabilizing frame created by global stiffness of muscles in the part of the body that is moving. Thus, increased feedforward stability offers a mechanism akin to training wheels on a bicycle, allowing wobble of a movement, while remaining upright and within the general planned trajectory path.

A second difference is that the present mechanism offers a categorical reduction in the computational complexity required to conduct feedback correction of errors that impact overall stability (i.e., preventing falls), such as a humanoid robot maintaining balance and not falling over when there is an unexpected obstacle. One of the most limiting components of existing technology for error correction in robotics is the computational demand of the current rote approach of continuously calculating errors and correcting them immediately before they negatively impact the robot. This method is not only inefficient, but also very difficult to program and to cover/capture all possible errors. The mechanism in this invention removes the need for this rote approach, and replaces it with a much simpler approach. The simplification is due to the co-contraction mechanism used (see figures and figure legends), which stabilizes without having to calculate and correct the exact error, and general stabilization can be achieved with relatively few basic programs. This mechanism also runs in parallel to the movement program, rather than requiring alterations to the movement program itself and, thus, can be added to existing technology. The mechanism by which it functions is to activate a global stabilization network to counteract the movement error or unstable position and move the robot back toward a baseline position, rather than making joint-by-joint corrections. The force of this mechanism is greater than the force of the movement itself, and thus is able to counteract the error/instability resulting from the movement. In many cases, this may be implemented by pre-programmed, stereotyped responses, much like postural reflexes used in humans.

An instability detection mechanism may be used with the present invention to facilitate selection of specific stability programs. For example, a bubble level mechanism may be incorporated into the robot that detects the degree to which the robot is upright and stable. This mechanism is analogous to the construction and function of the inner ear semicircular canals. If the robot deviated by a certain amount from being level, stability mechanisms recruited in muscle-like components move the body back to its baseline position by using either a global stabilizing response, or a response in the direction opposite of the detected instability. The mechanism incorporates information about expected position (i.e., to only activate stability mechanisms if a position is not expected), given that the robot would need to maintain the ability to make planned movements away from the level position if properly stabilized. Another example may use a mechanism to activate stability responses in any muscle-like component that perceives a “stretch” outside the stable range.

This second example could be applied to a variety of robotic technologies, including robots with moving parts that are performing precision tasks (such as product assembly) or with a moving center of mass that has the potential for becoming off-balance (such as humanoid or other bipedal robots). The stability component is particularly applicable to robots moving over uneven terrain, as used in search and rescue efforts. Although drones currently used on uneven terrain are generally constructed with more than two legs to maximize stability, there are advantages to using bipedal robots over four or six-legged robots (e.g., ability to move through narrow spaces), if such robots could be manufactured to be more stable.

A third example of implementing the inventive concept involves improving performance of robots that need to learn new skills.

Specifically, the principles described above for improving fine motor control for prosthetics and in freestanding/moving robots can be specifically applied in robots that routinely need to learn and practice new skills (e.g., industrial robots, surgical robots, etc.). That is, a greater level of overall stiffness can be implemented across muscle-like features of the robot during learning, and this level can then be gradually reduced as the skill is learned. This example specifically refers to the “training wheels” concept described above in [0033] and [0049].

A fourth example of implementing the inventive concept involves improving signal detection for voice recognition or recognition of human movement.

Specifically, the principles described above for prosthetics (i.e., how to interpret the signal emerging from the nervous system), can also be applied to algorithms used for voice recognition or human movement detection. Similar to limb prosthetics that attempt to interpret outcoming signals from an arm stump, the ability to precisely identify and characterize features/identity of a voice or movement in space also requires knowledge of how the signals coming out of the system are organized. Both voice and movement signal are expected to include two superimposed, but parallel sets of signals (e.g., movement and stability signals). These signals can be decomposed into their predicted components when analyzing them, rather than trying to interpret the signals while still integrated. This results in both more accurate, and higher resolution information about the signals. This mechanism may be particularly useful at distinguishing between voices of different individuals, because it not only predicts two components to the signal, but also predicts there are significant differences in the relative weighting of these components across individuals.

Many of the underlying principles disclosed herein were discovered upon review of research conducted by Applicants on the human brain, which has led to recent advances in models of human motor control.

For example, the motor control research conducted by Applicants suggests that the brain possesses a functional system serving the general purpose of controlling body posture and overall mechanical stabilization required for motor control. This system is thought to be unified by the type of mechanism it applies to stabilize, rather than by any one specific behavior it produces. Specifically, the mechanisms include co-contraction of antagonistic muscles, contraction of muscles antagonistic to a movement, and co-contraction of groups of synergistic muscles. The application of these principles to robotic technology will allow significant advances in the degree of precision and stability that can be achieved in robots, while at the same time improving the efficiency and flexibility with which precision and stability are implemented.

The invention provides, among other things, robotic technology with improved efficiency, stability, flexibility, and accuracy/precision of motor control. The robotic technologies that benefit most from this invention are those that (a) require movement as similar as possible to humans, such as prosthetics or humanoid robots, and/or (b) have a demand for stability and flexibility of movement, such as a humanoid robot that encounters unpredictable obstacles. Because the mechanisms proposed in this invention follow the principles of the functional system thought to be overamplified in the movement disorder, dystonia, robots designed to use this mechanism can also potentially be used as a humanoid model of dystonia. Robots that are designed to do non-variant tasks, and that do not require improvements in stability or flexibility benefit significantly less from this invention.

The invention further allows improved algorithms for signal detection relating to human motor function. This includes voice recognition software and interpretation of neural information to control prosthetics, given that the motor components going into voice production and the signals coming out to control human limbs can be better predicted.

One inventive feature of this invention is the proposal to construct a “stabilization” system for robotic technology that operates via co-contraction of sets of motor units, to run in parallel with and with some level of mechanical opposition (or “antagonism”) to “movement” programs. This system increases the efficiency, stability, flexibility, and accuracy/precision of motor control for robotic technology, and is based on hypothesized principles of human motor control. While some existing robotic technology allows for direct correction of expected or perceived movement errors, the concept of using an independent stabilization control system to mechanically oppose the “movement” control system has not been used in robotic technology.

Another feature of this invention is that the mechanism proposed for posture/stabilization function is more elegant than the calculations currently used to correct movement and does not require as much precision to be effective. Specifically, it does not require calculation of exact vectors required to correct movement, whether correction is done prospectively or retrospectively. Instead, it offers mechanical resistance to the movement until the desired path has been achieved. Such function will reduce coding complexity (and thus increase the achievable level of stability/precision), particularly for the control of moving body parts themselves.

Another feature of the invention is that the mechanism proposed for posture/stabilization function may include a feedforward component that improves the overall mechanical stability of robots. The mechanism of co-contraction of muscle groups can be used as a prospective ballast against instability due to anticipated changes in the center of gravity. Current robots do not have such a ballast with the exception of the mechanical structure of parallel manipulators, but these are not currently used for larger, more human-like robot application, nor do they exhibit the functionality that is necessary for the dynamic component of the ballast in the current invention.

Another feature of the invention is that the principles of motor control described herein are equally applicable in the opposite direction to better understand and detect human motor function (i.e., to decompose, rather than synthesize the components of motor control). Specifically, assuming that motor signals are composed of at least two channels rather than a single channel, this indicates an analysis is required to detect predicted subcomponents of the signal (e.g., a fourier analysis) in order to properly analyze human motor function. Each motor “channel” is expected to exhibit different features (e.g., frequency, amplitude, and the like).

The invention has been described in connection with what are presently considered to be the most practical and preferred embodiments and applications. However, the present invention has been presented by way of illustration and is not intended to be limited to the disclosed embodiments. Accordingly, those skilled in the art will realize that the invention is intended to encompass all modifications and alternative arrangements within the spirit and scope of the invention as set forth in the appended claims.

We claim:

1. A motor control system to be applied to robotic technology, the motor control system comprising:
at least two actuators each including a first receiver and a second receiver, and mechanically arranged to provide antagonistic forces;
a movement control system communicating a first signal to the first receivers, the first signal indicative of a movement profile that produces mechanical movement forces; and
a stabilization control system communicating a second signal to the second receivers, the second signal indicative of a stabilizing profile that produces mechanical stabilizing forces that are antagonistic to the mechanical movement forces, the stabilizing profile does not require exact calculation of movement errors or stability errors, but can make use of knowing such errors if this information is available.

2. The motor control system of claim 1, wherein the movement control system and the stabilization control system are discrete and are not summed prior to communication with the actuator.

3. The motor control of claim 2, wherein the summation occurs immediately before reaching the actuator.

4. The motor control system of claim 1, wherein the stabilizing profile is used to achieve global stability function in robotic technology, and
wherein the stabilization profile may exert a net antagonistic force that is greater than, equal to, or less than the net force of the movement profile.

5. The motor control system of claim 1, wherein the stabilizing profile is used to modulate control, accuracy, precision, and/or speed of the movement profile, and
wherein the stabilization profile will exert a net antagonistic force that is less than the net force of the movement profile.

6. The motor control system of claim 1, wherein the stabilizing profile is used to invoke local stability to prevent or stop movement,
wherein the stabilizing profile will exert a net antagonistic force that is greater than the net force of the movement profile.

7. The motor control system of claim 1, wherein the movement control system and the stabilization control system communicate with each other.

8. The motor control system of claim 1, wherein the movement profile utilizes passive dynamics.

9. The motor control system of claim 1, wherein the stabilizing profile is applied on a feedforward basis.

10. The motor control system of claim 1, wherein the stabilizing profile is applied on a feedback basis.

11. The motor control system of claim 1, wherein the stabilizing profile is applied on both a feedforward and a feedback basis.

12. A method of detecting and at least one of analyzing and interpreting human motor signals, the method comprising:
utilizing an algorithm to segregate motor signals into a first signal representative of a movement profile and a second signal representative of a stabilizing profile; and
utilizing at least one of the first signal and the second signal.

13. The method of claim 12, wherein utilizing at least one of the first signal and the second signal includes determining whether or not the signals are representative of human motor function.

14. The method of claim 12, wherein utilizing at least one of the first signal and the second signal includes recognizing human identity.

15. The method of claim 12, wherein utilizing at least one of the first signal and the second signal includes operating a non-human device.

16. The method of claim 12, wherein the signals are related to the production of sound.

17. The method of claim 16, wherein utilizing at least one of the first signal and the second signal includes performing voice recognition.

18. The method of claim 12, wherein the signals are related to physical movement of at least one of the entire body, any group of body parts, and a single body part.

19. The method of claim 18, wherein utilizing at least one of the first signal and the second signal includes enacting a motor program with a prosthetic device.
